(19) United States
(12) Patent Application Publication
(10) Pub. No.: US 2026/0322086 A1
(43) Pub. Date: Oct. 15, 2026

(54) CLEANROOM-SUITABLE LINE PROTECTION GUIDE FOR ESD PROTECTED AREAS

(71) Applicant: IGUS GMBH, Köln (DE)

(72) Inventor: Dominik BARTEN, Meckenheim (DE)

(21) Appl. No.: 19/475,184

(22) PCT Filed: Apr. 11, 2024
(86) PCT No.: PCT/EP2024/059900

§ 371 Date: Oct. 14, 2025

(30) Foreign Application Priority Data
Apr. 15, 2023 (DE) 10 2023 109 519.6

(51) Int. Cl. H02G 3/04; F16G 13/16; H02G 11/00

(52) U.S. Cl. CPC H02G 3/0487; F16G 13/16; H02G 11/006

(57) ABSTRACT

A line protection guide for lines, such as for example cables, hoses or the like, in particular for cleanroom applications, having an elongate, flexible envelope which is displaceable to-and-fro, the envelope comprising at least one envelope unit which has at least one tubular receptacle for guiding at least one line, the respective receptacle extending duct-like in a longitudinal direction from a first end to a second end. The line protection guide is configured to dissipate electrostatic charges over at least one part of its longitudinal extent, so as to enable use of the line protection guide in ESD protected areas, the at least one envelope unit comprising a conductive or dissipative material.

### FIELD

The invention relates in general to the field of line guide apparatuses for lines, or supply lines, such as for example cables for signal or power supply or pneumatic or hydraulic hoses or the like, which need to be guided dynamically between connection points of a machine or installation, at least one connection point being mobile relative to the other.

The invention in particular proposes a dynamic line guide apparatus or line protection guide, which is suitable in particular for use in cleanrooms, for example in semiconductor or flat screen fabrication, in pharmaceutical installations, in medical devices, etc. In such applications, it is particularly undesirable for particles to be released by the line guide apparatuses and such release must be minimized to the greatest possible extent.

### BACKGROUND

Energy guide chains are typical line guide apparatuses of link construction, which however release particles when in operation due to abrasion. Even if the energy guide chain is of low-abrasion configuration, the guided lines themselves release particles when in operation as they move, bend and rub against one another on displacement. For example, the cable sheaths themselves also release particles into the environment on displacement. For this reason it is known to envelop the lines in dust-tight manner.

Line protection guides of the above type which are also suitable for cleanroom applications comprise an elongate, flexible envelope, which is displaceable reversibly or to-and-fro between a first connection point and a second connection point mobile relative thereto, the envelope being capable of forming two runs and a deflection arc between the runs on displacement. In this case, the proposed envelope has at least one envelope unit with a number of tube-shaped receptacles, i.e., at least one receptacle for guiding at least one line, each receptacle extending duct-like in a longitudinal direction from a first end to a second end of the envelope unit or the envelope.

A generic line protection guide typically has an end fastening device at at least one end or at both ends for connecting the end of the line protection guide to a connection point. The end fastening device can optionally also be used to close the end of the envelope to prevent particles from escaping.

The line protection guide may be fixed or mounted at its ends to the connection points by two such end fastening devices.

The longitudinal extent here relates in general to the longitudinal direction of the line protection guide, which corresponds to the longitudinal extent of the lines to be guided.

A line protection guide of the above type is proposed by the applicant in WO 2020/148596 A1, for example.

The known envelopes of such line protection guides are typically made of insulating plastics materials.

It has now been found that electrostatic charging of the envelope may occur during operation, for example through movement of the runs relative to one another. The problem is of increased relevance for line protection guides which comprise layers of two or more envelopes arranged one above the other, it being possible for electrostatic charging to occur between the layers or plies. Voltage fields arising as a result of large potential differences may lead to an abrupt discharge of the accumulated charge, which may cause harmful sparking or discharge arcs with high currents. This is undesirable in particular in sensitive areas or areas where static electricity is a risk (ESD protected areas) and must absolutely be avoided. This is typically the case in many cleanroom applications, for example in semiconductor fabrication or flat screen manufacture.

### SUMMARY

Against this background and in light of the above-stated technical problem, a first object of the present invention is to propose a line protection guide which at least in part overcomes the above-stated disadvantages.

According to the invention, it is proposed with regard to a line protection guide of the above type that the at least one envelope unit comprise a conductive or dissipative material, in particular that it consist at least in part or indeed entirely of a conductive or dissipative material, whereby the line protection guide is configured to dissipate electrostatic charges over at least one part of its longitudinal extent, in particular over the entire length, so as to enable use of the line protection guide in ESD (Electrostatic Discharge) protected areas.

In particular, the line protection guide may thereby comply with the requirements of standard DIN EN 61340-5-1 (2017-07). The conductive or dissipative material of the at least one envelope unit may in this case in particular have a surface resistance of between 1×10³ and 1×10⁹ ohm, in particular at 23 ° C and 50% relative humidity. The conductive or dissipative material may preferably have a surface resistance of between 1×10³ and 1×10⁶ ohm, particularly preferably of between 1×10⁴ and 1×10⁶ ohm. The above-stated values for surface resistance are specified in particular in DIN EN 61340-5-1 (2017-07), in particular section 5.2.2.

According to the invention, the stated object may be achieved merely by adding at least one conductivity-enhancing additive to the plastics material typically used to produce the envelope or envelope unit, for example a TPE. The additive may be selected such that the resultant plastics material of the envelope or envelope unit additionally has a sufficient level of the properties needed, in particular has resilience or flexibility for sustained flexural fatigue stress and is of sufficiently low-abrasion configuration for cleanroom applications.

If the line protection guide according to the invention, when arranged for operation as intended, is grounded or electrically connected with a potential serving as a reference potential (PE) for grounding purposes, it does not store any hazardous electrostatic charge. Grounding may in particular be implemented by at least one of the connection points, for example by an end fastening device, which is provided to connect the line protection guide to a mobile machine part or a fixed point. This enables dissipation of critical electrostatic charges which may arise through movement of the line protection guide. This may even be sufficient to ensure that no further shielding is needed for ESD-sensitive components on the machine or installation part supplied by the line protection guide.

The line protection guide has typically at least one end fastening device for connecting the end of the line protection guide to a connection point. This at least one end fastening device may likewise comprise a conductive or dissipative material which may differ from the conductive or dissipative material of the envelope unit or indeed be identical thereto.

The conductive or dissipative material which is part of the end fastening device can be in electrical contact with the conductive or dissipative material of the envelope unit, preferably also in direct physical or mechanical contact, such that the electrostatic charge may be conducted from the surface of the envelope to the end fastening device. The end fastening device, in particular at the stationary connection point, may in turn be connected with the reference potential serving for grounding.

The end fastening device can preferably also serve or be used to close the end of the envelope to prevent particles from escaping.

The conductive or dissipative material of the envelope unit and/or the conductive or dissipative material which is part of the end fastening device is preferably plastics-based, or consists to a large part of plastics material, which is modified by the addition of other substances, for example to adjust the conductivity thereof.

The conductive or dissipative material of the envelope unit and/or the conductive or dissipative material which is part of the end fastening device may comprise an elastomer, in particular a thermoplastic elastomer (TPE), as the plastics material.

The at least one envelope unit, in particular each envelope unit of the line protection guide, may comprise a conductive or dissipative material over its entire longitudinal extent, i.e., from one end to the other end thereof. In this respect, the envelope unit may in particular consist of a material composition which remains constant over the entire longitudinal extent and which preferably consists predominantly of a thermoplastic elastomer (TPE).

The envelope unit may consist of a first conductive or dissipative material. At least one component of the end fastening device may consist of a second, different conductive or dissipative material. The term material is in this case understood to be in particular but not necessarily synonymous with the term material composition, in particular a plastics composition with additives.

The conductive or dissipative material of the envelope unit (first material) and/or the conductive or dissipative material which is part of the end fastening device (second material) may be a plastics material with at least one additive for increasing conductivity. Metallic particles or carbon particles, fibers and the like are possible additives. In particular, carbon black, for example according to CAS No. 1333-86-4, is a possible additive. This is a soot-like material deliberately produced as an industrial primary material. Depending on its purpose, carbon black is a modification of carbon with a high surface-to-volume ratio and is primarily used as a filler and as a black pigment; however, it also demonstrably increases conductivity. Preferred carbon black consists of at least 85%, preferably at least 90%, carbon.

The conductive or dissipative material of the envelope unit and/or the conductive or dissipative material which is part of the end fastening device may alternatively or additionally also be a plastics material modified with salts to increase conductivity.

Including all additives, the plastics material of the envelope unit preferably has a Shore hardness in the range from 20 Shore A to 65 Shore D, in particular in the range from 50 Shore A to 100 Shore A. In contrast, the plastics materials which are used in the end fastening device have a higher hardness than the hardness of the envelope unit.

The at least one or each envelope unit may in particular be made in one piece. The envelope unit may in this respect form two or more tubular receptacles, or indeed just one tubular receptacle.

The envelope unit may in particular be produced using extrusion technology, in any event preferably from a plastics composition which is sufficiently dissipative/conductive for ESD protection.

The envelope may comprise one or more envelope units, which are arranged next to one another in a plane or vertically above one another. The multiple envelope units may share the same end fastening device or be secured by the same end fastening device.

The at least one envelope unit may be circumferentially closed, i.e., about an axis extending in the longitudinal direction. The at least one envelope unit may be circumferentially closed, such that the lines to be guided can only be removed or introduced in the longitudinal direction.

The at least one envelope unit may, however, preferably be opened and closed, in particular circumferentially closed using a closure bar or closure profiles, for example after lateral introduction of the line to be guided. The closure can be re-openable and re-closable.

Preferably, all the envelope units of the envelope are circumferentially closed, being either openable or not openable.

The at least one envelope unit may in particular have two closure profiles in one piece with the envelope unit, these closure profiles interacting, in particular in interlocked manner, as a closure for closing at least one receptacle.

The closure may in particular be form-and/or force-lockingly closable. The added additive for increasing conductivity may here optionally advantageously improve the mechanical properties of the closure, inter alia by slightly increased rigidity.

The envelope unit may have multiple receptacles, it being possible for at least some of the receptacles, preferably each of the receptacles, to have its own assigned closure. The respective receptacle may have its own closure profiles, which interact to close this receptacle. Different receptacles of an envelope unit may thereby be mutually independently filled. The respective receptacle may thus be optionally and individually opened for lateral access and then closed again.

The closure profiles preferably have the same cross-section throughout in the longitudinal direction. They may thus, for example, be produced as extruded profiles.

In a particularly advantageous embodiment, the interlocked closure profiles may comprise a hook profile and a claw profile, which preferably interact with a barb function. The closure profiles may here be provided between the envelope units laterally in the direction of the deflection axis, or alternatively on the envelope units radially inward or outward with regard to the deflection axis.

In a further embodiment, the at least one envelope unit may have two bilaterally opposing fastening strips or fastening profiles in one piece with the envelope unit, by way of which the envelope unit is connectable with a further envelope unit. The fastening strips or fastening profiles may connect two or more envelope units laterally next to one another in a plane. For the purpose of direct interaction, the fastening strips may be embodied so as to match one another, e.g., to interlock in conjugate or form-locking manner. They may also interact with a separate fastening bar which is used to fasten the envelope units together.

In one preferred embodiment, the at least one or each receptacle may be of rounded oblong or oval, in particular point oval, cross-section (perpendicular to the longitudinal direction) to reduce deformation in the deflection arc.

If the one or all receptacles of the envelope unit are of oval cross-section, the fastening strips are preferably arranged on the narrow sides of the receptacle(s).

In one embodiment, a support chain, in particular of individual chain links, is provided in one receptacle of the at least one envelope unit to support the envelope during displacement, this support chain being embodied in order to predetermine a deflection radius of the deflection arc and/or a self-supporting run in the extended position.

Two support chains are preferably arranged in at least one layer or ply, for example in each case in a lateral external receptacle. The line protection guide thus preferably comprises two support chains, each one in particular in respective lateral receptacles of the envelope. The support chain may then reduce or even prevent sagging of the envelope, which is advantageous in particular in the case of two or more layers of envelope units possibly arranged one above the other. This minimizes friction between the layers, which may contribute to reducing electrostatic charging of the envelope.

In one embodiment, the end fastening device may have a number of strain relief elements with in each case a clamping surface for one or more lines, at least one strain relief element of the number of strain relief elements comprising a conductive or dissipative material for dissipating electrostatic charges. The strain relief element may have a volume resistivity of less than or equal to 1×10⁹ ohm×cm, in particular measured according to DIN EN 61340-5-1 (2017-07). In this embodiment, the strain relief element is thus a part of the end fastening device which includes a conductive or dissipative material, in particular a second conductive or dissipative material.

Alternatively or additionally, the end fastening device may have a number of retaining elements in each case for one support chain, at least one retaining element of the number of retaining elements comprising a conductive or dissipative material for dissipating electrostatic charges. This may be a third conductive or dissipative material which is different from the first and/or second materials. The retaining element may be configured to retain a chain link, in particular an end chain link, of the support chain against displacement in the longitudinal direction relative to the end fastening device and to this end it may in particular have a retaining indentation for receiving a locking projection of the chain link, in particular of the end link of the support chain, protruding in the transverse direction transversely of the longitudinal direction.

The conductive or dissipative material of the strain relief element may differ from the conductive or dissipative material of the envelope unit and/or from the conductive or dissipative material of the retaining element. Thus, the line protection guide may as a whole comprise a plurality of different conductive or dissipative materials. The at least one envelope unit may comprise a first conductive or dissipative material. The at least one strain relief element of the end fastening device may comprise a second conductive or dissipative material. The at least one retaining element of the end fastening device may comprise a third conductive or dissipative material. The first, second and/or third materials may differ for example in Shore hardness or in flexural rigidity or in modulus of elasticity. The material of the envelope unit may for example be more pliable or flexibly resilient than the material of the strain relief element and in particular of the retaining element.

The first, second and/or third conductive or dissipative materials here interact in particular to dissipate electrostatic charging and form a suitably conductive path for dissipating reference potential. In one embodiment, at least two of the three materials used may also be identical or substantially identical in terms of composition.

The end fastening device preferably comprises at least two clamping plates with major faces for exerting a clamping force, in particular at least two flat clamping plates. The clamping force may be generated by clamping means such as clamping screws, clamping clips, quick-release clamping devices or the like. In one embodiment, the clamping plates are each made of an electrically conductive material, preferably of metal, particularly preferably of aluminum. The end fastening device, in particular the clamping plates, may be grounded, i.e., electrically connected directly or indirectly (optionally via strain relief elements and/or retaining elements etc.) with the reference potential, in order to ensure dissipation of the electrostatic charges from the envelope to the ground. Through suitable fastening, for example screwing, the clamping plates may in particular exert a clamping force on envelope unit(s), strain relief elements and/or retaining elements so as to ensure direct physical or mechanical contact for the purpose of electrical contacting.

The number of strain relief elements are preferably arranged between the mutually facing major faces of the clamping plates, in order to transfer the clamping force from the clamping plates to the at least one line, the number of strain relief elements and/or the number of retaining elements preferably interacting undoably by form-locking connection with at least one of the clamping plates. This allows rapid assembly of the end fastening device, the strain relief elements or the retaining elements remaining connected with one of the clamping plates on removal of means bringing about clamping force, such as clamping screws, clamping clips, quick-release clamping means or the like.

In one embodiment which is particularly advantageous for cleanrooms, the end fastening device may be configured to close the end of the envelope against the escape of particles, i.e., to technically minimize such escape. For example, the end fastening device may close at least some of the receptacles of the envelope unit at the end against the escape of particles from this receptacle in the longitudinal direction, for example by pressing the envelope against the lines to be conducted. In this embodiment, the particles escape only to a minimal extent, or not at all, even at the end-face ends of the envelope.

In one advantageous embodiment, the line protection guide in each case has an end fastening device for the envelope at both ends. At least one end fastening device is in this case preferably connected with the reference potential serving for grounding, both end fastening devices preferably being electrically grounded, such that the shortest possible dissipation path is achieved over in each case roughly at most half the length of the envelope unit(s). The two end fastening devices are preferably of like construction, as described above, in particular with dissipative strain relief elements and/or retaining elements.

According to a further independent aspect, the invention also relates to an envelope unit for a line protection guide.

The proposed envelope unit is in particular suitable for a line protection guide according to one of the above embodiments. The proposed envelope unit has at least one tubular receptacle for guiding at least one line, the receptacle extending duct-like in the longitudinal direction from a first end to a second end.

According to the invention, the envelope unit is configured to dissipate electrostatic charges and comprises a conductive or dissipative material. This enables use, in particular of the line protection guide, in ESD protected areas.

The conductive or dissipative material can, for example, be a plastic modified with salts to increase conductivity.

In this case, the envelope unit may advantageously be embodied such that it has one or more of the above-explained features which further develop the envelope unit per se.

### BRIEF DESCRIPTION OF THE DRAWINGS

Further details and advantages of the invention may be inferred, without restricting the general nature of the above, from the following explanation of preferred exemplary embodiments on the basis of the appended drawings. In the drawings:

FIGS. 1A-1D are perspective views of a line protection guide for cleanroom applications, here with two envelopes, in a purely exemplary operating position with an extended self-supporting upper run, an extended stationary lower run and a deflection arc therebetween (FIG. 1A); an example of an envelope unit with circumferentially closed receptacles in cross-section transversely of the longitudinal direction (FIG. 1B); a perspective view of a fragment of an envelope unit with circumferentially closed receptacles (FIG. 1C); and a fragment of a support chain in longitudinal section (FIG. 1D);

FIGS. 2A-2D show an example of an end fastening device for a line protection guide according to FIG. 1A in side view (FIG. 2A) and in perspective view (FIG. 2B); an example of an end member of a support chain in plan view (FIG. 2C;); and an example of a retaining element of the end fastening device for the end member of the support chain (FIG. 2D) in perspective view;

FIGS. 3A-3C show a front view of a further example of an envelope unit, which has a plurality of receptacles which are individually closable and openable (FIG. 3A); the same example with lines inserted (FIG. 3B); and an enlarged depiction of preferred associated closure profiles (FIG. 3C).

### DETAILED DESCRIPTION

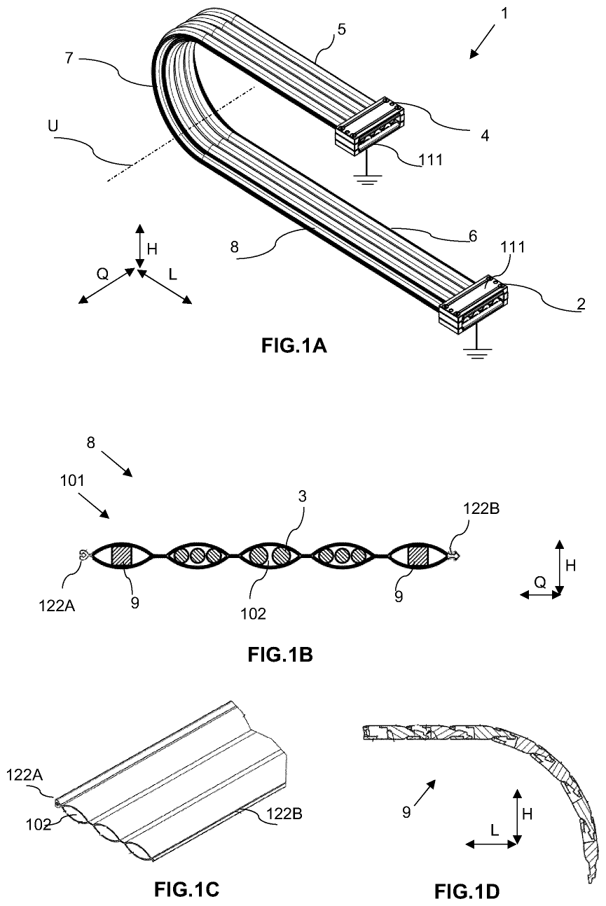

FIG. 1A shows an exemplary line protection guide 1 which guides supply lines 3 between a stationary connection point 2 on a base and a mobile connection point 4 on a moving end. The moving end is not shown in any greater detail and can typically be displaced to-and-fro in linear manner in the longitudinal direction L. The supply lines 3 are cables, hoses or the like and supply the mobile part of a machine for example with power, signals and/or operating media. The line protection guide 1 is suitable and intended in particular for cleanrooms or other fields of application in which the release of particles must be reduced or prevented. To this end, it has a flexible envelope 8 extended in the longitudinal direction L and which comprises, in the example shown, two envelope units 101 arranged vertically above one another which enclose the supply lines 3 in dust-tight manner along their entire length between the connection points 2 and 4. The ends of each envelope unit 101 and of the lines 3 are fastened at the end to the connection points 2, 4, for example using end fastening devices 111 or end connections. Here, the line protection guide 1 and the connection points 2, 4 are grounded or connected electrically to ground, for example by the end fastening devices 111. This serves in discharging any electrostatic charges which may arise as a result of movement of the line protection guide 1, in particular of the two-layered envelope 8. This prevents sudden discharges and sparking, which is undesirable in particular in ESD protected areas. The principle factor contributing to the ESD suitability of the line protection guide is the selection of the conductive or dissipative material of the envelope 8 and the components of the end fastening device 111, as is described further below.

FIG. 1A shows a snapshot of the line protection guide 1, the envelope 8 forming a self-supporting, extended upper run 5, a lower run 6 optionally lying on a bearing surface, and a deflection arc 7. The deflection arc 7 has a predetermined bending radius or deflection radius about a notional deflection axis U which extends in the transverse direction Q perpendicular to the longitudinal direction L and perpendicular to the height direction H. When in operation, the deflection arc 7 travels to-and-fro relative to the stationary connection point 2 when the upper run 5 with the mobile connection point 4 travels forward or backward in the longitudinal direction L.

FIG. 1B shows merely by way of example a possible internal subdivision for one of the two envelope units 101 in a cross-section perpendicular to the longitudinal direction L. The one-piece envelope unit 101 forms a plurality of ducts as receptacles 102. In FIG. 1B the envelope unit 101 has by way of example five duct-like or tubular receptacles 102 for one or more supply lines 3 or bundles of lines and two support chains 9 in the outer receptacles, which predetermine the radius of the deflection arc 7 and support a self-supporting length of the advanced upper run 5. FIG. 1C shows a further example of an envelope unit with three receptacles 102. FIG. 1D shows by way of example a fragment of a support chain 9 composed of individual chain links inserted in one another. The respective adjacent chain links are connected swivelably together, the possible swivel angle being defined by limit stops of the chain links. In this way, it is not possible to fall short of the predetermined deflection radius and the lines are protected from overbending or kinking.

The envelope unit 101 has a fastening strip 122A, 122B along each of its narrow long sides, the two fastening strips 122A, 122B being complementary to one another and being connectable together in a joining direction corresponding to transverse direction Q. This enables the envelope unit 101 to be connected to further envelope units with matching fastening strips or to an identical envelope unit. In this way, the envelope 8 can be added to in transverse direction Q.

The envelope 8 or the envelope unit 101 is made of a flexible, pliable plastics material, in particular an elastomer, preferably a thermoplastic elastomer, which comprises additives for increasing the conductivity thereof. The material of the envelope is suitable for dissipation and is selected so as to meet the requirements of standard DIN EN 61340-5-1 (2017-07) for ESD protected areas and under the relevant intended operating conditions has a surface resistivity of between 1×10⁴ and 1×10⁶ ohm. In one exemplary embodiment, this is achieved in that the material comprises a thermoplastic elastomer (TPE), for example thermoplastic polyurethane (TPU) elastomer, comprising dispersed carbon black particles.

In another exemplary embodiment, the material is a TPE comprising dispersed aluminum particles.

In another exemplary embodiment, the material is a TPE which is modified by salts (dopants/doping agents for polymers, in particular elastomers) to increase conductivity or is suitable for so doing. Such salts appear particularly well suited to cleanrooms because they can optionally be adjusted to be lower abrasion than plastics materials modified with carbon black. Examples of suitable salts are lithium salts, for example lithium perchlorate, lithium trifluoromethane sulfonate, and lithium hexafluorophosphate; tetraalkylammonium salts, for example tetraethylammonium tetrafluoroborate, tetraethylammonium chloride; organic salts such as tetracyanoquinodimethane (TCNQ) and derivatives, or indeed sodium chloride, sodium iodide and potassium iodide. In other exemplary embodiments, the plastics material may be thermoplastic rubber (TPR), or an elastoplastic, which is modified with carbon nanofibers or carbon nanoparticles to establish the desired conductivity.

It is also possible to use as the material a TPE which comprises a combination of different conductivity-enhancing additives, for example with two of the above-stated additives, for example with carbon black particles, aluminum particles and/or one of the stated dopants or salts.

The envelope unit 101 has a cross-section perpendicular to the longitudinal direction L which remains constant throughout. The envelope unit 101 may be produced inexpensively as a strand product using suitable plastics extrusion technology and cut to a suitable length, for example of around 100 mm to around 1500 mm. All the receptacles 102 within the envelope unit 101 are spatially separate from one another, circumferentially closed and lie next to one another in transverse direction Q. The envelope unit 101 surrounds the lines 3 or support chains 9 over the longitudinal extent in dust-tight manner and thus prevents the escape of particles, which arise for example through abrasion or wear.

FIGS. 3A-3C show a particularly preferred further example of an envelope unit 301. Here too, the envelope unit 301 is made, preferably extruded, from a flexible, bendable plastics material, and has a plurality of, for example three, receptacles 102 for lines 3 in the closed state (FIG. 3B). The envelope unit 301 has its own respective closure for each receptacle 102, here in particular in the form of a strip-like closure bar with two closure profiles 311 or engagement profiles interlocked in conjugate manner, namely a hook profile 311A which may engage in a claw profile 311B. The hook profile 311A and the claw profile 311B are in each case provided with at least one undercut, preferably two symmetrical undercuts and engage in one another with a barb function, i.e., are relatively easy to close or connect but require the application of distinctly greater force to undo.

In other embodiments which are not shown, some receptacles 102 of an envelope unit are produced circumferentially closed, for example the receptacles for the support chains, and the other receptacles 102 of the envelope unit are provided with closure profiles 311 for opening and closing.

Furthermore, the envelope unit 301 likewise has a fastening strip or fastening profile 122A, 122B on both opposing narrow sides for modular fastening in one layer of multiple envelope units 301 with correspondingly identically constructed or complementary fastening profiles. The fastening strips or profiles 122A, 122B are here likewise embodied as a claw profile 311B or hook profile 311A similar or of identical construction to the closure profiles 311.

FIG. 3C is a schematic diagram of enlarged cross-sectional representations of the hook profile 311A or the claw profile 311B, which are of identical construction for the closure profiles 311 and for fastening profiles 122A, 122. The hook profile 311A and the claw profile 311B have a constant cross-section throughout in the longitudinal direction (perpendicular to the plane of FIG. 3C) and are embodied as flexible bars or strips which are bendable in the deflection arc 7 (FIG. 1A) about the axis U. Other structural shapes of a hook profile 311A or a claw profile 311B, in particular as known with toothless zippers, in particular ziplock or sliding closures, of plastics materials are also possible options.

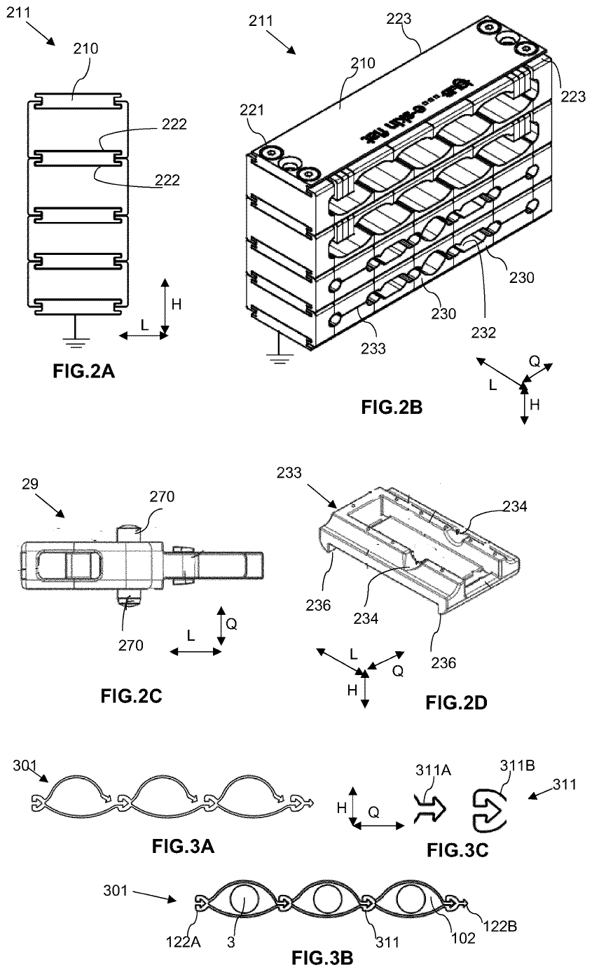

FIGS. 2A-2B show a particularly preferred example of an end fastening device 211. The end fastening device 211 is usable at both ends of the line protection guide 1. It has a number of clamping plates 210 of identical construction, which are produced in FIGS. 2A-2D as substantially flat rectangular plates of metal, for example of an extruded aluminum profile. The clamping plates 210 form a major face 222 on each major side for exerting a clamping force and are arranged with their principal direction, which corresponds to the longitudinal extent of the clamping plate 210 or the transverse direction Q of the line protection guide, perpendicular to the longitudinal direction L of the envelope 8 (cf. FIG. 1A). All the clamping plates 210 are of like construction and have two long narrow sides 223, which extend in the transverse direction Q and transversely of which the lines 3 are conducted, and two short narrow sides.

The end fastening device 211 in FIGS. 2A-2B is of multilayer construction, for a plurality of envelope units 101, 201 one on top of the other, and comprises in each layer a number of modular strain relief elements 230 of different designs. In each of the exemplary four layers shown here, identical strain relief elements 230 are respectively located opposite one another in pairs between two clamping plates 210. The strain relief elements 230 are of block-like configuration and in this example have a trough on one major side which is open on both sides in the longitudinal direction L. Two associated strain relief elements 230 thereby form, in mutually opposing operating arrangement relative to the height direction H (FIG. 2B), a generally cylindrical recess with a clamping surface 232 for force-locking retention of one or more lines 3 (cf. FIG. 1B) in the respective duct-like receptacle 102 together with the envelope unit 101. The strain relief elements 230 are modular and are configured for strung-together, opposing arrangement between facing major faces 222 of the clamping plates 210 and, when arranged for operation as intended, press at the ends of the envelope 8 against the lines 3 and prevent particles from being able to escape from the envelope 8 in the region of the end fastening device in the longitudinal direction L. This also makes the line protection guide 1 suitable for use in cleanrooms.

The strain relief elements 230 are thus pressed against the dissipative material of the envelope 8 or of the envelope unit 101, 301 by the clamping plates 210 and are also in electrical contact with the dissipative material of the envelope unit 101, 301 and with the conductive material of the respective clamping plate 210, i.e., with metal of the clamping plate 210. The respective end fastening device 111, 211 is electrically connected with the ground (cf. FIG. 1A), for example by grounding the clamping plates. The strain relief elements 230 are injection-molded from a conductive or dissipative thermoplastic elastomer (TPE), which is adjusted to the prescribed conductivity for conductive or dissipative materials for ESD protected areas to DIN EN 61340-5-1 (2017-07) by the addition of carbon particles, for example carbon nanoparticles, carbon fibers, silicon powder or aluminum powder or fibers. The specific resistivity of the material is 1×10⁴ to 1×10⁶ ohm×m. The contact resistance of a strain relief element 230 is preferably less than or equal to 1×10⁶ ohm. The material of the strain relief elements 230 differs from the material of the envelope unit by higher flexural rigidity. The electrostatic charges which arise by movement of the envelope 8 are transmitted by the dissipative material of the envelope units 101, 301, via the strain relief elements 230 and via the metallic clamping plates 210, to the grounding point. The electrical resistance of the line protection guide to the grounding point is ≤1×10⁹ ohm.

As FIGS. 2C-2D show, at the respective end chain link or end link 29 of the support chain 9 two locking projections 270 facing away from one another are in each case provided which in each case protrude laterally, in a direction substantially parallel to the transverse direction Q at the respective one of the external side faces of the end link 29. To lock the respective support chain 9 in the longitudinal direction L, the clamping plates 210 are in each case provided with a pair of identically constructed, opposing chain link retaining elements 233, at the two end fastening devices 111; 211, cf. FIG. 1A or FIG. 2B.

The chain link retaining elements 233 are shown in greater detail in FIG. 2D and in each case have two laterally and transversely opposing retaining indentations 234, which take the form of semi-cylindrical troughs each for form-lockingly receiving roughly half the cross-section of one of the locking projections 270. In this way, two chain link retaining elements 233 in the form of identical parts may in each case be used in pairs for end fastening of the support chain 9 with the assistance of the end links 29 thereof in each case at the two end fastening devices. The two lateral locking projections 270 at each end link 29 engage for locking in each case in the corresponding retaining indentation 234 in the associated chain link retaining element 233, to lock the support chain 9 in the longitudinal direction L.

The respective retaining element 233 may likewise be made of a conductive or dissipative thermoplastic which has been modified by conductive additives. The material of the retaining elements differs from the material of the envelope unit 101; 301 and from the material of the strain relief elements 230 by a higher flexural rigidity and a higher Shore hardness.

The respective retaining element 233 has connecting regions 236 on the side remote from the retaining indentations 234. The respective strain relief elements 230 has similar connecting regions (not shown) on the side remote from the clamping surface 232. The connecting regions 235 interact by form-fitting or force-fitting connection with narrow sides of the clamping plate 210, for example they engage in a T-groove on a narrow side of the clamping plate 210. In this way, even after the clamping screws 221 have been undone, the strain relief elements 230 and the retaining elements 233 remain connected to one of the clamping plates 210, such that the end fastening device does not fall apart. This simplifies assembly.

### LIST OF REFERENCE SIGNS

1 Line protection guide
2,4 Connection points
3 Line or supply line
5; 6 Runs (upper run, lower run)
7 Deflection arc
8 Envelope
9 Support chain
29 End link of the support chain
101; 301 Envelope unit
102 Receptacle of the envelope unit
111; 211 End fastening device
122A, 122B Fastening strip
210 Clamping plate
221 Clamping screws
222 Major faces of the clamping plate
223 Long narrow side of the clamping plate
230 Strain relief element
232 Clamping surface of the strain relief element
233 Retaining element for the support chain
234 Retaining indentation in the retaining element
235 Connection regions of the retaining element
270 Locking projection of the end link
311 Closure profile
311A Hook profile
311B Claw profile
L Longitudinal direction
Q Transverse direction
H Height direction

What is claimed is:

1-18. (canceled)

19. A line protection guide for lines, such as for example cables, hoses or the like, in particular for cleanroom applications, having an elongate, flexible envelope which is displaceable to-and-fro, in particular forming a deflection arc between two runs, the envelope comprising at least one envelope unit which has at least one tubular receptacle for guiding at least one line, the respective receptacle extending duct-like in a longitudinal direction from a first end to a second end, and wherein the line protection guide has at least one end fastening device for connecting the end of the line protection guide to a connection point, wherein:
the line protection guide is configured to dissipate electrostatic charges over at least one part of its longitudinal extent, so as to allow use of the line protection guide in ESD protected areas, the at least one envelope unit comprising a conductive or dissipative material; and
the end fastening device comprises a conductive or dissipative material which is in electric contact, in particular in direct contact, with the conductive or dissipative material of the envelope unit, and may differ therefrom, wherein:
the end fastening device comprises at least two clamping plates with major faces for exerting a clamping force;
the end fastening device has at least two strain relief elements with in each case a clamping surface for one or more lines;
the strain relief elements are arranged between mutually facing major faces of the clamping plates, to transfer the clamping force from the clamping plates to the at least one line;
at least one of the strain relief elements comprises a conductive or dissipative material for dissipating electrostatic charges.

20. The line protection guide according to claim 19, wherein the at least one end fastening device is designed for closing the end of the envelope to prevent particles from escaping.

21. The line protection guide according to claim 19, wherein the conductive or dissipative material of the envelope unit and/or the conductive or dissipative material of the end fastening device is plastics-based.

22. The line protection guide according to claim 19, wherein the conductive or dissipative material, in particular the conductive or dissipative material of the envelope unit, comprises an elastomer, in particular a thermoplastic elastomer, the at least one envelope unit preferably comprising a conductive or dissipative material over its entire longitudinal extent from one end to the other, and the at least one envelope unit consisting in particular of a material composition which remains constant over the entire longitudinal extent and which preferably consists predominantly of a thermoplastic elastomer.

23. The line protection guide according to claim 19, wherein the conductive or dissipative material is a plastics material with additive for increasing conductivity.

24. The line protection guide according to claim 19, wherein the conductive or dissipative material is a plastics material modified by salts to increase conductivity.

25. The line protection guide according to claim 21, wherein the plastics material of the envelope unit preferably has a Shore hardness in the range from 20 Shore A to 65 Shore D, in particular in the range from 50 Shore A to 100 Shore A.

26. The line protection guide according to claim 19, wherein the at least one envelope unit is embodied in one piece and in particular forms a plurality of tubular receptacles. Title: CLEANROOM-SUITABLE LINE PROTECTION GUIDE FOR ESD PROTECTED AREAS

27. The line protection guide according to claim 19, wherein the at least one envelope unit is circumferentially closed.

28. The line protection guide according to claim 19, wherein the at least one envelope unit has two closure profiles in one piece with the envelope unit, these closure profiles interacting, in particular in interlocked manner, as a closure for closing at least one receptacle, the closure profiles preferably having the same cross-section throughout in the longitudinal direction.

29. The line protection guide according to claim 28, wherein the interlocked closure profiles comprise a hook profile and a claw profile, which interact in particular with a barb function.

30. The line protection guide according to claim 19, wherein the at least one envelope unit has two bilaterally opposing fastening strips or fastening profiles in one piece with the envelope unit, by way of which the envelope unit is connectable with a further envelope unit.

31. The line protection guide according to claim 19, wherein a support chain is provided in at least one receptacle of the at least one envelope unit to support the envelope during displacement.

32. The line protection guide according to claim 19, wherein:
the end fastening device has a number of retaining elements in each case for at least one support chain, the at least one retaining element of the number of retaining elements comprising a conductive or dissipative material for dissipating electrostatic charges;
the conductive or dissipative material of the strain relief element in particular differing from the conductive or dissipative material of the envelope unit and/or from the conductive or dissipative material of the retaining element.

33. The line protection guide according to claim 32, wherein the end fastening device comprises at least two flat clamping plates, the clamping plates preferably each being made of an electrically conductive material, preferably of metal, preferably of aluminum, the number of strain relief elements and/or the number of retaining elements preferably interacting undoably by form-locking connection with at least one of the clamping plates.

34. The line protection guide according to claim 19, wherein:
the line protection guide in each case has an end fastening device for the envelope at both ends, at least one end fastening device being connected with the reference potential serving for grounding; and/or
the or each end fastening device is configured to close the end of the envelope against the escape of particles.

35. The line protection guide according to claim 19, wherein the at least one strain relief element is made of a conductive or dissipative thermoplastic elastomer, which contains carbon particles, carbon fibers, silicon powder, aluminum powder or aluminum fibers.

36. The line protection guide according to claim 35, wherein the specific resistivity of the material of the strain relief element is 1×10⁴ to 1×10⁶ ohm×m, and/or the contact resistance of a strain relief element is less than or equal to 1×10⁶ ohm.
